(19) United States
(12) Patent Application Publication
(10) Pub. No.: US 2008/0065275 A1
(43) Pub. Date: Mar. 13, 2008

(54) METHOD AND SYSTEM FOR CONTROLLING MANNED AND UNMANNED AIRCRAFT USING SPEECH RECOGNITION TOOLS

(75) Inventor: Anthony Vizzini, Starkville, MS (US)

Correspondence Address: DLA PIPER US LLP;ATTN: PATENT GROUP, 500 8th Street, NW, WASHINGTON, DC, 20004-2131, US

(73) Assignee: MISSISSIPPI STATE UNIVERSITY, Mississippi State, MS (US)

(21) Appl. No.: 11/688,045

(22) Filed: Mar. 19, 2007

Related U.S. Application Data
(60) Provisional application No. 60/783,579, filed on Mar. 17, 2006.

(51) Int. Cl. G05D 1/00; G10L 15/00

(52) U.S. Cl. 701/2; 701/120; 704/275

(57) ABSTRACT

A system and method is provided for controlling an aircraft. At least one transceiver is provided to receive a voice instruction from an air traffic controller, and transmit a voice response to the air traffic controller. A response logic unit can be provided to interpret the received voice instruction from the air traffic controller, determine a response to the interpreted voice instruction, and translate the interpreted voice instruction to a command suitable for input to at least one autopilot unit. An autopilot unit can also be provided to receive the command from the response logic unit, wherein the command is configured to guide the flight of the unmanned aircraft.

### CROSS REFERENCE TO RELATED APPLICATIONS

This application is based on, and claims priority to, U.S. Provisional Application Ser. No. 60/783,579, filed Mar. 17, 2006, the entire contents of which are hereby incorporated by reference.

### BACKGROUND

1. Field of the Invention

This invention relates to the control of unmanned aircrafts and the automated control of manned aircrafts using speech recognition techniques.

2. Discussion of the Background

Unmanned aircrafts (UAs) have grown in increased popularity and complexity over the years. Such increased popularity and complexity of UAs have raised the issue of ways to control these vehicles. There are currently in existence operator interfaces for planning and controlling UAs such as the Multi-Modal Immersive Intelligent Interface for Remote Operation (MIIIRO), and/or the Integrated Sensor Suite-Integrated Mission Management Computers (ISS-IMMC). As used herein, MIIIRO refers to an operator interface for planning and controlling unmanned aerial vehicles (UAVs), unmanned tactical aircrafts (UTAs) and other remote systems. The ISS-IMMC refers to sensors and computers that provide the flight and navigation controls for the aircraft. The UAs can be operated in either of three control modes namely autonomous control mode, manual control mode, or shared control mode.

In the autonomous control mode, the UA flies according to an approved flight plan and executes specific tasks at various locations along the route of flight. The flight plan comprises a sequence of commands. Each command initiates a different task. Some commands may be configured to fly the UA back to its base location, while others may be configured to cause the UA to execute tasks such as orbiting around a location, capturing images, and/or landing. Manual control mode can incorporate input from either a joystick or a graphical user interface (GUI) to provide control inputs to the UA. An instrument panel may aid the operator in controlling the UA when it is under manual control. Operators are then able to view airspeed, altitude, vertical speed and other vehicle status indicators such as fuel remaining and total flight time on their instrument panel. Shared control can be achieved by mixing inputs from the operator and the autonomous flight control system. Shared control may be useful in situations such as maneuvering to evade potential threats or flying at low altitudes in order to capture close-up images of items of interest along the route of flight. The operator can select, from the shared control panel, the axes to be controlled autonomously and those to be controlled manually.

Civil and commercial market UA applications are so much more varied in scope than government/military applications, and are virtually untapped especially in the commercial sector. The current state of the art is embodied in the Northrup Grumman's Global Hawk®. The Global Hawk® was the first UA certified for instrument flight rules (IFR) operations through a radio relay link. This feature allows the Global Hawk® to fly within controlled airspace during a ferry mission even though typical operations of the Global Hawk® are outside of most civilian airspace. Communications from the Air Traffic Controller (ATC) are relayed to the operator monitoring the flight of the Global Hawk® who in turn responds to ATC. However, there is a need to eliminate the role of the operator who is monitoring the flight of the UA so that control of the aircraft can be directed by the ATC while still adhering to system reliability and safety requirements mandated by the FAA.

### SUMMARY

A system and method is provided for controlling an unmanned aircraft. According to one embodiment, there is provided a system and method for controlling an unmanned aircraft, including at least one transceiver to receive a voice instruction from an air traffic controller, and transmit a voice response to the air traffic controller. At least one response logic unit is also provided to interpret the received voice instruction from the air traffic controller, determine a response to the interpreted voice instruction, and translate the interpreted voice instruction to a command suitable for input to at least one autopilot unit. The at least one autopilot unit is provided to receive the command from the response logic unit, wherein the command is configured to guide the flight of the unmanned aircraft.

In another embodiment, there is provided a system and method for controlling a manned aircraft, including at least one transceiver to receive a voice instruction from an air traffic controller, and transmit a voice response to the air traffic controller. The system and method also provides at least one response logic unit connected to the at least one transceiver to interpret the received voice instruction from the air traffic controller, determine a response to the interpreted voice instruction, and translate the interpreted voice instruction to a command suitable for input to at least one autopilot unit. The at least one autopilot unit receives the command from the response logic unit, wherein the command is configured to guide the flight of the unmanned aircraft. At least one visual display unit is also provided to display the received voice instruction from the air traffic controller so that the received instruction is understood by a pilot of the manned aircraft.

### BRIEF DESCRIPTION OF THE DRAWINGS

Reference is made to the attached drawings, wherein elements having the same reference designations represent like elements throughout and wherein:

FIG. 1 illustrates a block diagram of a Response Expert System (RES) for controlling the operations of an unmanned aircraft (UA) in controlled airspace.

FIG. 2 illustrates a block diagram of a Response Expert System for general aviation (GA) applications.

FIG. 3 illustrates a block diagram of the functional interfaces for implementing standard instrument flight rules (IFR) in a manned aircraft.

FIG. 4 illustrates a block diagram of functional interfaces for operating an unmanned aircraft using the Response Expert System (RES) during instrument flight rules operations.

FIG. 5 illustrates a block diagram of the functional interfaces and operations of an enhanced manned operation of a general aviation aircraft.

### DETAILED DESCRIPTION

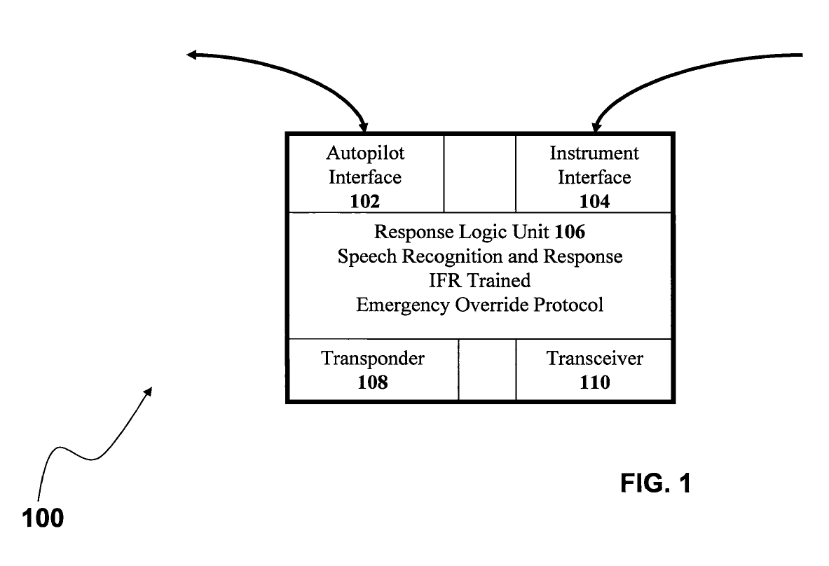

FIG. 1 illustrates a block diagram of a Response Expert System (RES) 100 for controlling the operations of an unmanned aircraft (UA) in controlled airspace. The controlled airspace can be a civilian airspace. The embodiments described below are methods and systems involving a device that operates as a man-in-loop to mimic the radio communications of piloted air vehicles. Ninety-eight percent of the UA market is currently used for government or military applications, which are serviced by more than fifty producers with over 150 UA designs. The UA industry desire to penetrate the commercial UA market. However, current UA designs either fail to meet expected commercial market needs and/or fail to meet most aviation authority restrictions (e.g., Federal Aviation Administration (FAA)) for use in a controlled airspace environment. Therefore, the FAA, for example, allows UAs in controlled airspace on a case by case basis only. When operating in controlled airspace, UAs must follow Instrument Flight Rules (IFR) as manned aircraft do. These rules govern civilian aircraft operations in controlled airspace. IFR aircraft must have an ATC clearance for the flight. Such clearance can contain the route of flight, altitude restrictions, and a clearance limit for the flight. System reliability and safety issues, especially see-and-avoid problems are major contributing factors to the hesitation to open controlled airspace to UAs.

In instrument flight rules (IFR) operations, communication between the air traffic controller (ATC) and the pilot is constant during the flight cycle. Such communication enables collision avoidance by ensuring that an aircraft adheres to a collision-free flight pattern. For redirection during flight from a previously filed flight plan, the ATC commands piloted vehicles through maneuvers during all aspects of IFR operations. The RES 100 receives radio messages from an ATC, executes directives based on the radioed messages, and reports back to the ATC that the messages have been received and are being executed. To the tower operator or ATC, there is no perceived difference in his/her communication with the unmanned aircraft than with a manned vehicle. The RES 100 is configured to hear the message and respond. Such embodiments described herein differs from that used to control the Global Hawk® by eliminating the role of the operator who is monitoring the flight.

The RES 100 allows an UA to safely operate in controlled airspace and to comply with all of an aviation authority's requirements for manned aircrafts. The air traffic controller may have the ability to direct and/or control all aircrafts in the airspace regardless of whether it is manned or unmanned. The control methodology of the RES 100 also addresses issues arising from see-and-avoid problems. In an embodiment, the RES 100 controls the UA operations in civilian airspace. As used herein, the UA RES 100 is a computer based unit that runs in parallel with other systems on an aircraft. The UA RES 100 can include a Response Logic Unit (RLU) 106, a transceiver 108, and/or a transponder 110. As used herein, the transponder refers to an electronic device that produces a response when it receives a radio-frequency interrogation. An aircraft may have transponders to assist in identifying such aircrafts on radar and on other aircraft's collision avoidance systems. A transponder may receive signals from an uplink station (e.g., an ATC), and then convert the received signals to a new frequency. Such converted signals may be amplified, and then sent (downlinked) back to the ATC. The transponder may be configured with two-way interfaces (uplink and downlink) with the autopilot, and onboard sensors and instruments. The RLU 106 is the “smart” component that interprets ATC communication messages which are received by the RES 100. The RLU 106 then provides the corresponding response messages which are relayed to the ATC via the RES.

The RLU 106 can be developed using computer software that is recognizes and adheres to IFR requirements. Instrument Flight Rules (IFR) as used herein refer to a set of regulations and procedures for flying an aircraft without the assumption that pilots will be able to see and avoid obstacles, terrain, and other air traffic. IFR can be an alternative to visual flight rules (VFR) where the pilot is primarily or exclusively responsible for see-and-avoid. Under IFR, navigation and control of the aircraft is done by instruments. While flying through clouds may be permitted by an aviation authority for an aircraft flying under IFR, such flying through clouds may be prohibited under VFR.

The RLU 106 can contain speech recognition and response capabilities. Such capabilities enable the RES 100 to respond accurately to voice commands received from the ATC by converting, for example, the voice commands into computer text that is then processed by the RES 100. Further, the RLU 106 interfaces with other aircraft instruments (e.g., altimeter, airspeed, vertical velocity, GPS, transponder, etc.) via the instrument interface 104. When an incoming radio transmission is received, it is determined whether such transmission pertains to the UA. If it is determined that the radio transmission pertains to the UA, the UA RES 100 may respond to the ATC via the transceiver 110. Appropriate action is determined and performed by the RLU 106 when the radio transmission calls for a change to the current autopilot settings, the transceiver frequency and/or or the transponder code. The ATC can have control over the UA when the UA is flying in controlled air space.

Such control by the ATC and the RES 100 offer increased safety to GA aircraft operations. As an example, an ATC control can instruct the UA to land, if necessary. The ATC can have the ability to transmit an override signal from its ground control in order to activate an emergency override protocol of the UA. Such emergency override can be activated to override certain functions (e.g., autopilot) of the UA. The emergency override signal can be transmitted via radio and/or wireless communications to the RES 100 from the ATC in order to deactivate the autopilot and place the aircraft in manual control mode. As one example, when a pilot fails to respond to the ATC, a series of diagnostics are run. The ATC determines if the aircraft received its transmitted messages. If so, the ATC can infer a host of corresponding factors. The ATC may infer that the transmission communication is operating in good condition; the aircraft is within range; the pilot must be tuned in to the proper radio frequency; and/or the pilot is able to respond. In the absence of a response from the pilot, the RES 100 can be configured to respond to the ATC. Thus, the ATC would have a better understanding of the situation, and may be able to eliminate any failure points between the transmission and reception of the signal. If the pilot continues to be non-responsive, the controller can direct the aircraft to conduct maneuvers in order to maneuver clear of conflicting traffic, avoid controlled airspace regions, and/or stabilize the flight path of the aircraft. Further, the device could be coupled with life-saving devices such as a ballistic recovery system to allow for safe recovery of the aircraft.

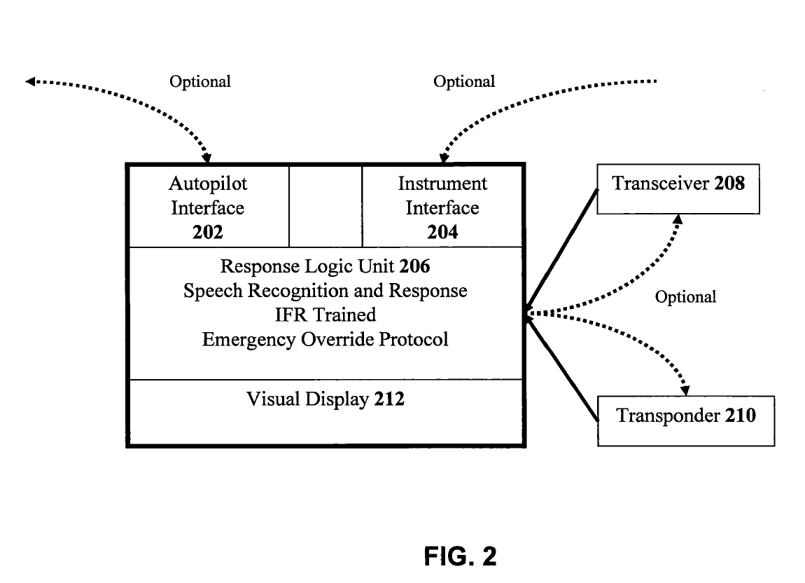

FIG. 2 is a diagram of the RES for general aviation (GA) applications. The GA RES 200 may include a RLU 206, an autopilot interface 202, an instrument interface 204, and a visual display 212. The visual display 212 helps enhance a pilot's understanding of an air traffic controller's messages by displaying such messages. This helps reduce errors in the pilot's understanding of the messages. The pilot can then confirm receipt of the communication message and then execute instructions associated with the message, as required. The RLU 206 can be configured to use a GA aircraft transceiver 208 and/or transponder 210. The RLU 206 may be developed with computer software that is IFR trained. Such software may also be developed to contain speech recognition and response capabilities. RLU 206 interfaces with other instruments (e.g., altimeter, airspeed, vertical velocity, GPS, transponder, etc.) via the instrument interface 204. Such interfacing between the RLU 206 and the instruments may occur on a read-only basis in non-emergency situations wherein such readings help increase the awareness of the RLU 206. However, in order for the GA RES 200 to provide commands to the aircraft in emergency situations (e.g., where the pilot has not responded appropriately to ATC instructions) the transceiver, transponder, and autopilot can be configured to permit overriding commands from the RLU. An emergency override signal can also be transmitted via radio and/or wireless communications to the RES 200 from the ATC in order to deactivate the autopilot and place the aircraft into a manual control mode.

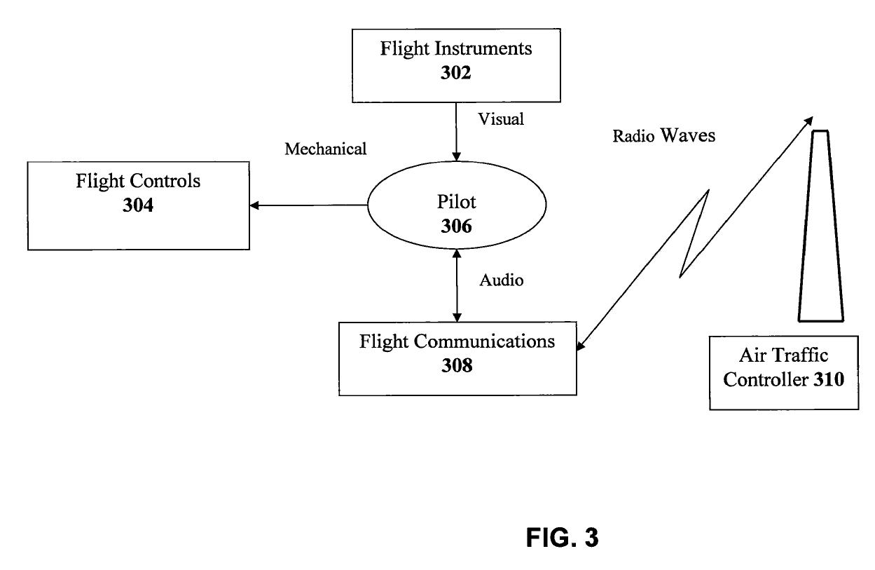

FIG. 3 illustrates the functional interface for standard IFR aircraft operations. In The ATC 310 communicates with a manned aircraft via the aircraft's flight communications 308. The flight communications may be in the form of an aircraft transceiver radio. The aircraft's radio 308 (transceiver) receives the radio signals and provides them audibly to the pilot 306. The pilot 308 can then communicate back to the ATC 310, the status of the aircraft. Such status may include information relating to the location, altitude, airspeed, and/or heading of the aircraft. The pilot 306 can then make any necessary adjustments to the flight path through the flight control system 304 of the aircraft either through manual control or the autopilot. The pilot adjustments to the flight control may be mechanical or electronic in form. The pilot 306 may visually verify any adjustments made to the status of the aircraft using the flight instruments 302 having navigation displays associated with each flight instrument.

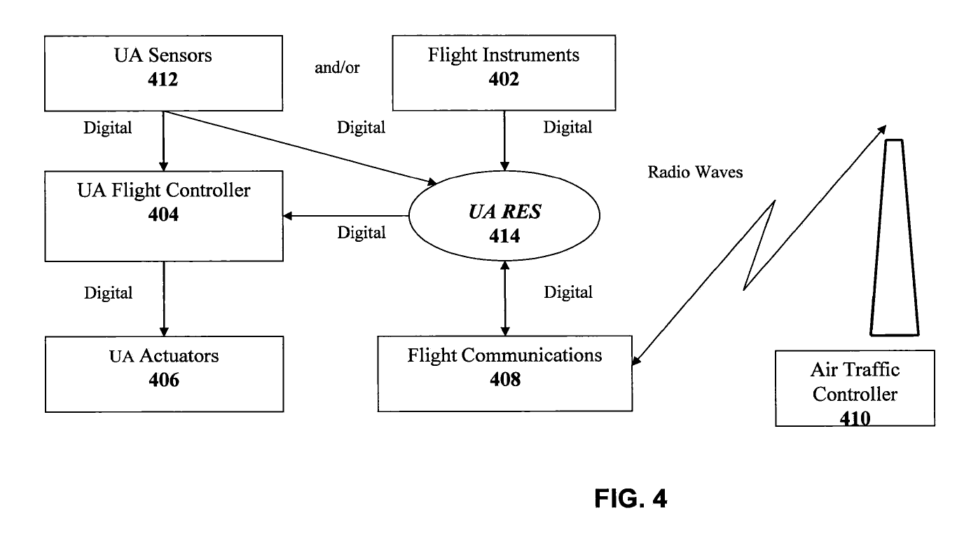

FIG. 4 illustrates a block diagram of functional interfaces for operating an unmanned aircraft using the Response Expert System (RES) during instrument flight rules operations. In an embodiment, the ATC 410 may communicate with the aircraft via radio and/or transponder that are associated with the aircrafts flight communication 408. The ATC communications to the aircraft are determined through speech recognition software configured within the RLU of UA RES 414. Such speech recognition capabilities enable the UA RES 414 to respond accurately to voice commands received from the ATC by converting, for example, the voice commands into computer text that is then processed by the UA RES 414. Further, the UA RES 414 interfaces with flight instruments 402 (e.g., altimeter, airspeed, vertical velocity, GPS, transponder, etc.). The UA RES 414 can determine the status of the aircraft either through the use of the flight instruments 402, as in a manned aircraft scenario or through the UA sensors 412. Such status information can be downlinked from the UA RES 414 to the ATC 410. Thus, the UA RES 414 can communicate back to the ATC 410 and instruct the UA's autopilot to make any adjustments to the flight plan of the aircraft based on the status information. When necessary, the UA RES 414 can initiate communications with ATC 410, such as when the UA RES 414 completes a directed maneuver, or when the UA RES 414 is requested to accomplish other tasks such as, changing ATC frequencies. The UA RES 414 can then make any necessary adjustments to the flight path through the UA flight controller 404 of the aircraft. The UA RES 414 adjustments to the flight control may be digital in form, and can depend on the sensors readings received from the UA sensors 412. The directed maneuvers may then be accomplished via the UA actuators 406 based on information it receives from the UA flight controller 404.

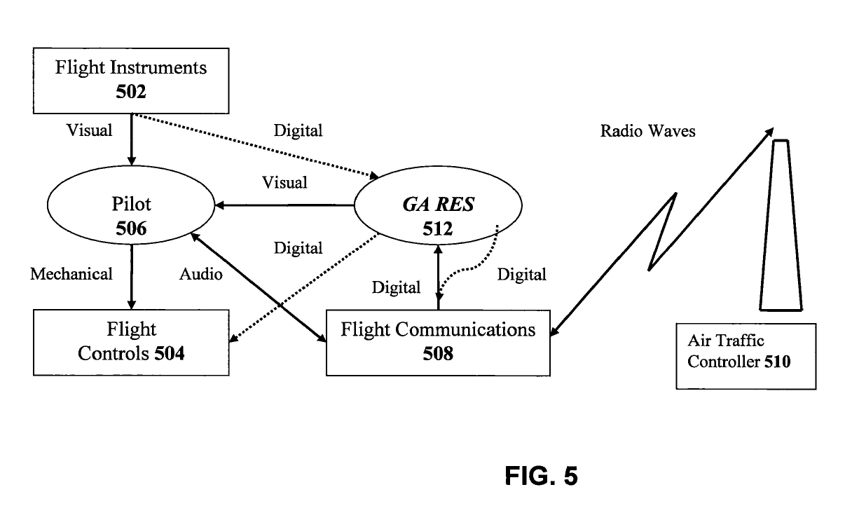

FIG. 5 illustrates a block diagram of the functional interfaces and operations of an enhanced manned operation of a general aviation aircraft. The GA RES 512 serves as an extra communication path between the ATC 510 and the pilot 506. In addition to the audible messages, the GA RES 512 can display the text of messages associated with the ATC 510. The GA RES 512 can also alert the pilot 506 of additional concerns such as, immediate compliance with the directed maneuvers. The dotted paths, as shown in FIG. 5, indicate emergency operations of the GA RES 512 in a manned aircraft. The GA RES 512 may be able to determine the current status of the aircraft through the downlink used to display aircraft instruments 502, and then, be able to execute the necessary maneuvers through the uplink to the aircraft's autopilot system or flight controls 504.

The GA RES 512 can receive audio signals from an aircraft transceiver in the same manner that the pilot hears it over his/her headset. In an embodiment, the GA RES 512 may be connected to the transceiver's headset output and microphone input. The RLU uses speech recognition software to determine the words being spoken by ATC 510. This speech recognition and response can be limited to vocabulary associated with aviation and/or to individuals trained in proper diction. The RLU then parses the message and displays it on a visual display associated with the GA RES 512.

In an embodiment, the GA aircraft is configured with emergency safety features. Therefore, if the pilot 506 does not respond as required, the GA RES 512 may make contact with the ATC 510 via the flight communications 508. The ATC 510 then determines whether the GA RES 512 should control the aircraft by commanding the transceiver, transponder, and/or autopilot. An emergency override signal can be transmitted via radio and/or wireless communications to the GA RES 512 from the ATC 510 in order to deactivate the autopilot and place the aircraft into a manual control mode. This is also referred to as the Emergency Override Protocol (EOP).

While the present invention has been described in connection with the illustrated embodiments, it will be appreciated and understood that modifications may be made without departing from the spirit and scope of the invention.

What is claimed is:

1. A system for controlling an unmanned aircraft, comprising:
a transceiver to:
receive a first voice instruction from an air traffic controller, and
transmit a voice response to the air traffic controller;
a response logic unit connected to the transceiver, the logic unit being configured to:
interpret the received first voice instruction from the air traffic controller,
determine a response to the interpreted first voice instruction, and
translate the interpreted first voice instruction to a command suitable for input to an autopilot unit; and
an autopilot unit configured to receive the command from the response logic unit, and guide the flight of the unmanned aircraft in accordance with the command.

2. The system of claim 1, further comprising:
a plurality of sensors connected to the response logic unit to monitor the flight of the aircraft.

3. The system of claim 1, wherein the response logic unit comprises a database that stores instrument flight rules commands and/or emergency override protocols.

4. The system of claim 1, wherein the response logic unit comprises an interface to a transponder, and wherein the response logic unit is configured to control a setting of the transponder in response to command from the air traffic controller.

5. A method for controlling an unmanned aircraft, comprising:
receiving a first voice instruction from an air traffic controller;
interpreting the received first voice instruction from the air traffic controller;
determining a voice response to the interpreted first voice instruction;
transmitting the voice response to the air traffic controller;
translating the interpreted first voice instruction to a command suitable for input an autopilot unit; and
providing the command to the autopilot unit, wherein the autopilot unit is configured to guide the flight of the unmanned aircraft in accordance with the command.

6. The method of claim 5, further comprising:
monitoring a flight parameter using an aircraft instrument to verify compliance with the first voice instruction; and
transmitting a voice message to the air traffic controller when compliance with the first voice instruction has been verified.

7. The method of claim 6, wherein the flight parameter is a parameter selected from a group consisting of heading, speed, and altitude.

8. The method of claim 6, further comprising:
storing instrument flight rules having command codes and/or emergency override protocols within a database associated with the unmanned aircraft.

9. The method of claim 5, further comprising:
receiving a second voice instruction from the air traffic controller;
interpreting the second voice instruction;
translating the second voice instruction to a second command suitable for input to a transponder; and
transmitting the second command to the transponder, whereby a setting of the transponder is modified in accordance with the second command.

10. A system for controlling a manned aircraft, comprising:
an interface to a transceiver configured to receive a first voice instruction from an air traffic controller via the transceiver and transmit a voice response to the air traffic controller via the transceiver;
a response logic unit connected to the transceiver, the response logic unit being configured to:
interpret the first voice instruction received from the air traffic controller;
determine a response to the interpreted first voice instruction; and
translate the interpreted first voice instruction to a command suitable for input to an autopilot unit;
an autopilot unit connected to receive the command from the response logic unit, wherein the autopilot unit is configured to guide the flight of the manned aircraft in accordance with the command; and
at least one visual display unit to display the received first voice instruction from the air traffic controller in text form.

11. The system of claim 10, further comprising a plurality of sensors connected to the response logic unit to monitor the flight of the aircraft.

12. The system of claim 10, wherein the response logic unit comprises a database that stores instrument flight rules commands and/or emergency override protocols.

13. The system of claim 10, wherein the response logic unit comprises an interface to a transponder, and wherein the response logic unit is configured to control a setting of the transponder in response to the command from the air traffic controller.

14. A method for controlling a manned aircraft, comprising:
receiving a first voice instruction from an air traffic controller;
interpreting the received first voice instruction from the air traffic controller;
determining a voice response to the interpreted first voice instruction;
transmitting the voice response to the air traffic controller;
translating the interpreted first voice instruction to a command suitable for input an autopilot unit; and
providing the command to the autopilot unit, wherein the autopilot unit is configured to guide the flight of the manned aircraft in accordance with the command; and
displaying the received first voice instruction from the air traffic controller in text form.

15. The method of claim 14, further comprising:
monitoring a flight parameter using an aircraft instrument to verify compliance with the first voice instruction; and
transmitting a voice message to the air traffic controller when compliance with the first voice instruction has been verified.

16. The method of claim 15, wherein the flight parameter is a parameter selected from a group consisting of heading, speed, and altitude.

17. The method of claim 14, further comprising:
storing instrument flight rules having command codes and/or emergency override protocols within a database associated with the manned aircraft.

18. The method of claim 14, further comprising:
storing flight control commands from the air traffic controller,
receiving a second voice instruction from the air traffic controller,
converting the received second voice instruction into an analog voice signal,
converting the analog voice signal into a digital voice signal,
interpreting the digital voice signal in order to recognize the second voice instruction,
retrieving the stored flight control commands corresponding to the recognized second voice instruction; and
converting the retrieved flight control commands into digital signals in order to control the flight of the aircraft.

19. A method for controlling a manned aircraft, comprising:
downlinking flight instrumentation readings to an air traffic controller;
uplinking safety instructions from the air traffic controller based on the downlinked readings;
receiving radio signals from the air traffic controller;
interpreting the received radio signals;
determining aircraft status based on a comparison of the interpreted radio signals and the uplinked safety instructions;
communicating the determined aircraft status to the air traffic controller; and
receiving adjustment instructions from the air traffic controller based on the communication.

20. The method of claim 19, further comprising:
displaying the received adjustment instructions.
